(19) United States
(12) Patent Application Publication
(10) Pub. No.: US 2008/0017426 A1
(43) Pub. Date: Jan. 24, 2008

(54) Modular vehicle system and method

(76) Inventors: Raul J. Walters, Columbia, MO (US); Gordon W. Clune, La Canada, CA (US); Cody I. Glenn, Los Angeles, CA (US); Michael Kacaba, Topanga, CA (US); Aaron Lehnhardt, Mission Viejo, CA (US); Brian Huff, Newbury Park, CA (US); Tyrone W. Henry, Newbury Park, CA (US); Kirk C. Swanson, Simi Valley, CA (US); Peter F. Hutchinson, Valley Center, CA (US); Christopher D. Gable, Los Angeles, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/726,728

(22) Filed: Mar. 22, 2007

Related U.S. Application Data
(60) Provisional application No. 60/785,019, filed on Mar. 23, 2006.

(51) Int. Cl. B60F 3/00; B60K 6/20; B62D 25/00

(52) U.S. Cl. 180/65.2; 180/89.1; 296/193.04

(57) ABSTRACT

A modular vehicle system, for enabling configuration thereof as required. The system includes a core vehicle, and a module, for enabling configuration of the core vehicle as required, able to be integrated into the core vehicle, and able to be disconnected from the core vehicle for interchange thereof with another module.

### CROSS-REFERENCE TO RELATED APPLICATION

This application is claiming the benefit of a co-pending provisional application Ser. No. 60/785,019 filed on Mar. 23, 2006.

### BACKGROUND OF THE INVENTION

1. Field of the Invention

This invention is generally related to a vehicle, and more particularly, to a modular vehicle system and method for providing multiple functional capabilities, which is adaptable, serviceable and deliverable.

2. General Background and State of the Art

A multi-purpose vehicle, able to be utilized for military, homeland security, and disaster/emergency response, should be versatile. It should be able to protect the operators, and be highly deliverable to any site, adaptable, maintainable and agile. Also, it should be capable of light or heavy load and armor carrying, and rugged terrain operation.

The vehicle should be capable of performing a wide variety of mission-specific functions within the time requirements, and be maneuverable, fast and agile.

Further, the vehicle should be efficiently powered, provide enhanced maneuverability for the operators, and provide superior firepower as needed.

### INVENTION SUMMARY

Briefly, and in general terms, the present invention, in a preferred embodiment, by way of example, is directed to a modular vehicle system, for enabling configuration thereof as required. The system includes a core vehicle, and a module, for enabling configuration of the core vehicle as required, able to be integrated into the core vehicle, and able to be disconnected from the core vehicle for interchange thereof with another module.

In accordance with other aspects of the invention, there is further provided a modular vehicle wherein the core vehicle includes a chassis, a main body tub, mounted on the chassis, and components, connectable to the chassis and the main body tub.

In other aspects of the invention, the modular vehicle further includes a second module, for enabling configuration of the core vehicle as required, able to be integrated into the core vehicle, and able to be disconnected from the core vehicle for interchange thereof.

In yet still another aspect of the invention, the second module is able to be interchanged with the first module for integration into the core vehicle, and the first and second modules include quick disconnect couplers for enabling interchange thereof.

In still other aspects of the invention, the modular vehicle also includes components which are connectable relative to the chassis and the main body hub of the modular vehicle system, including wheel hub motors, suspension modules, removable engine and generator modules, vehicle armor, an extender unit, a flat bed, a front cockpit area, an enclosed cabin, a rear bumper, tandem seats, and a diesel/electric hybrid drive.

In further aspects of the present invention, the modular vehicle includes electronics, radio and computerized components, including a controller, remote controls, redundant backup systems, implementation and communications programs, aircraft loading guide, and turret gun bearings.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a perspective view of a first configuration of a modular vehicle;

FIG. 2 is an exploded view the first configuration of a modular vehicle;

FIG. 3 is a perspective view of a second configuration of a modular vehicle;

FIG. 4 is a side perspective partly open view of a third configuration of a modular vehicle;

FIG. 5 is a side perspective view of a fourth configuration of a modular vehicle;

FIG. 6 is a rear perspective view of a fifth configuration of a modular vehicle;

FIG. 7 is a rear perspective view of a sixth configuration of a modular vehicle;

FIG. 8 is a side elevational partly open view of a seventh configuration of a modular vehicle;

FIG. 9 is a side perspective view of an eighth configuration of a modular vehicle;

FIG. 10 is a side perspective view of a ninth configuration of a modular vehicle;

FIG. 11 is a side perspective view of a tenth configuration of a modular vehicle;

FIG. 12 is a perspective view of an eleventh configuration of a modular vehicle;

FIG. 13 is a perspective view of operators in tandem-seating in a modular vehicle;

FIG. 14 is a side elevational view of operators in tandem-seating in a modular vehicle;

FIG. 15 is a side outline view of a modular vehicle towing another vehicle up an incline.

### DETAILED DESCRIPTION OF THE PREFERRED EMBODIMENTS

Referring to the drawings, in which like reference numerals refer to like or corresponding parts, the modular vehicle according to the invention is a multi-use, highly deliverable, light or heavy load carrying, highly adaptable, hybrid, rugged terrain, armor capable, highly agile, utility and tactical modular vehicle.

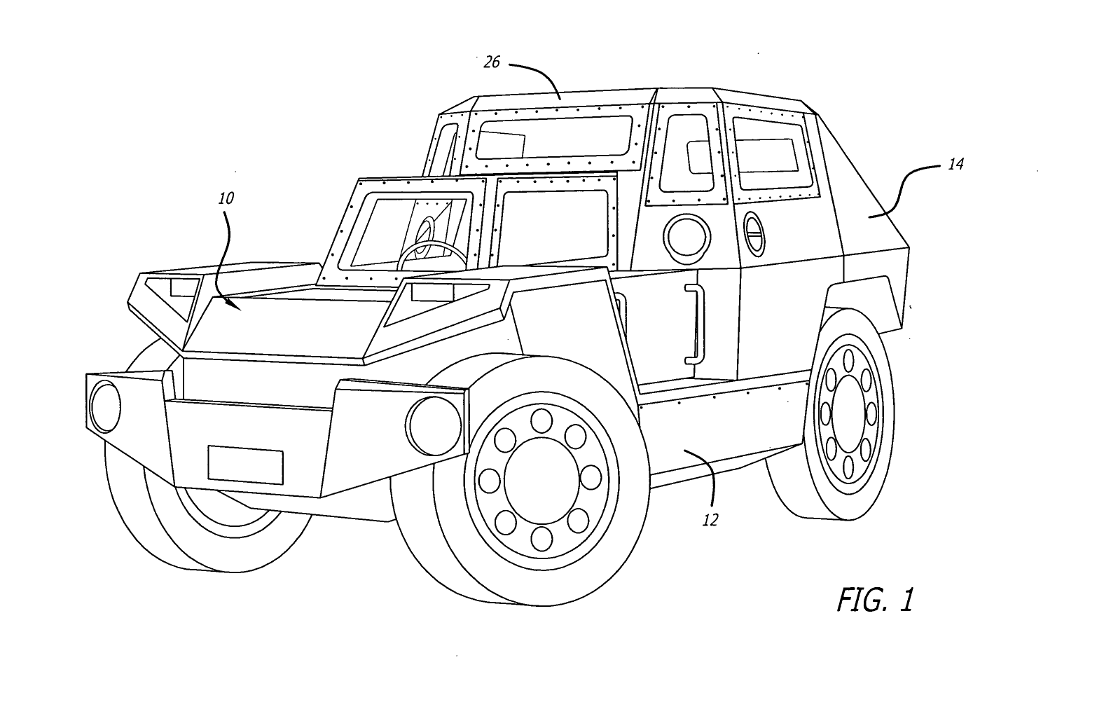

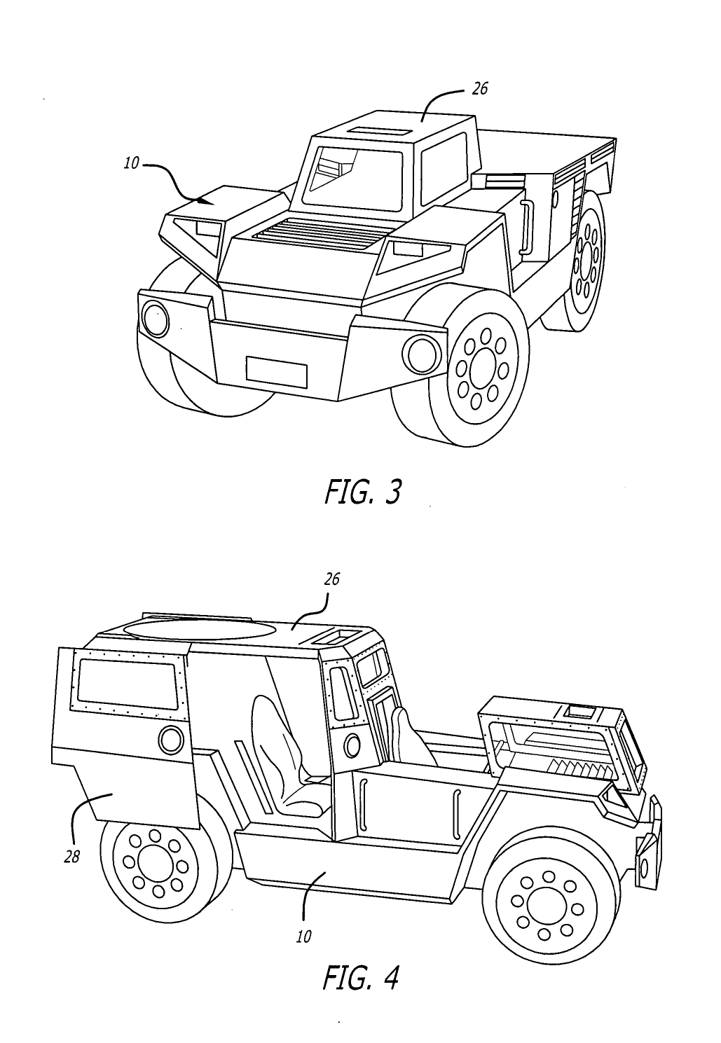

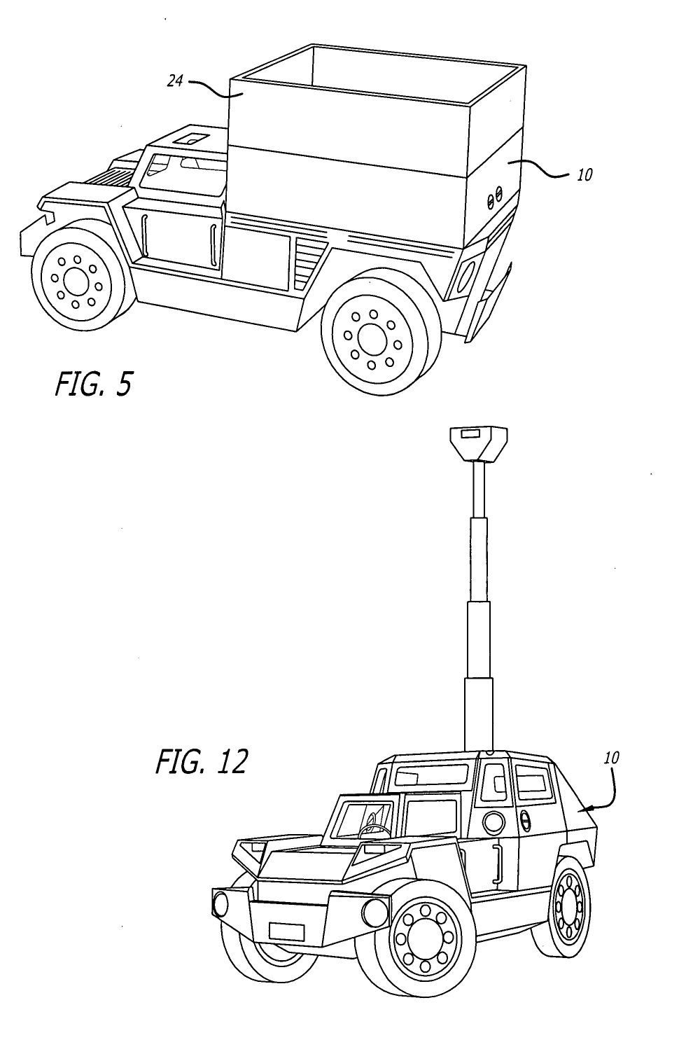

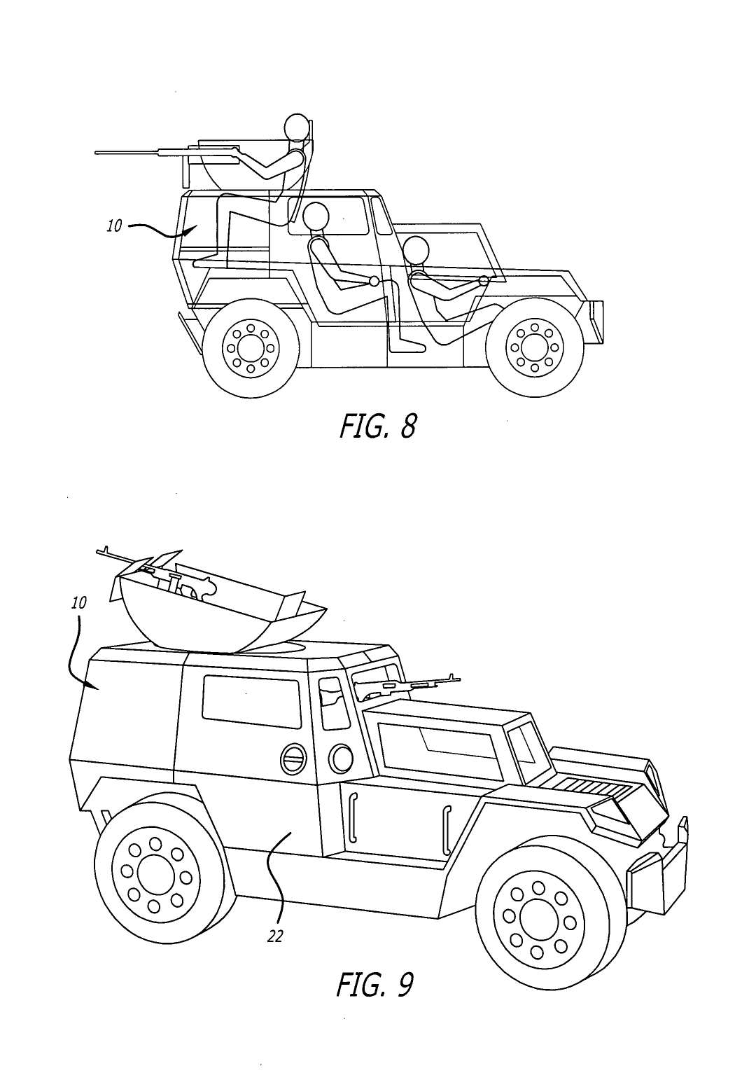

The modular vehicle of this invention, as described herein and illustrated in FIGS. 1-15, has multiple capabilities of function, serviceability, deliverability and adaptability. It has, among others, application to homeland security, disaster/emergency response, and the military. It is capable of enabling operations such as first responders, special operations forces, rapid reaction and expeditionary forces, convoy protection, installation and border security, foreign internal defense, general purpose military, and general purpose police and sheriff departments for special purpose missions such as drug enforcement, civil disturbance, bomb detection and disposal, and chemical and biological threats.

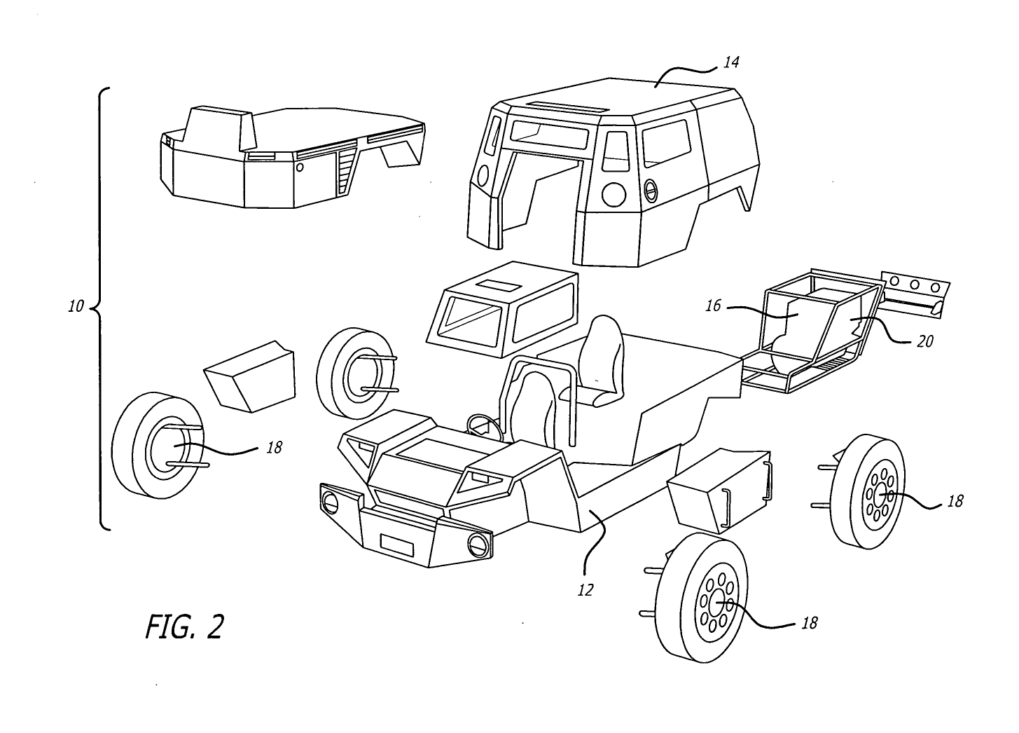

The modular vehicle 10, as illustrated in FIGS. 1 and 2, has a basic design which includes a vehicle tub/chassis 12—where either a flatbed or an enclosed rear cabin 14 can be placed thereon (and can be switched back and forth therebetween).

The vehicle comprises a modular, adaptable, maintainable, vehicle platform. It is a force multiplying vehicle platform, that increases the potential for the successful completion of a broad range of multi-faceted missions, while decreasing the exposure to loss of life or limb for the operators. It is also a dependable, multi-mission, next-generation, rugged terrain, armored, high speed light tactical vehicle, which enhances the capabilities and survivability of first responders for police and soldiers in harms way.

The vehicle platform provides deliverability, operator survivability, agility, speed, power, load carrying capability, stealth, deliverability of firepower and sustainability, and is modular, adaptable, and maintainable. It includes a core vehicle, wherein modules can be added thereto in order to meet specific mission requirements. For example, by adding modules, one individual core vehicle may be configured and then reconfigured as a light weapons platform, a multi-passenger tactical combat vehicle, a multi-litter ambulance, and a reconnaissance vehicle all during the course of a single day, if required. For convoy escort, as in FIGS. 9-11, the vehicle is small enough to maneuver past and around convoy vehicles, and fast and agile enough to maintain position or pass at convoy speeds.

In addition to all of the mission-specific modules of the vehicle being common between vehicles, the core vehicle is made up of common modules to allow for rapid maintenance, whereby only the damaged or non-working module is left in the maintenance facility, while the core vehicle, with a replacement module in place, immediately returns to service.

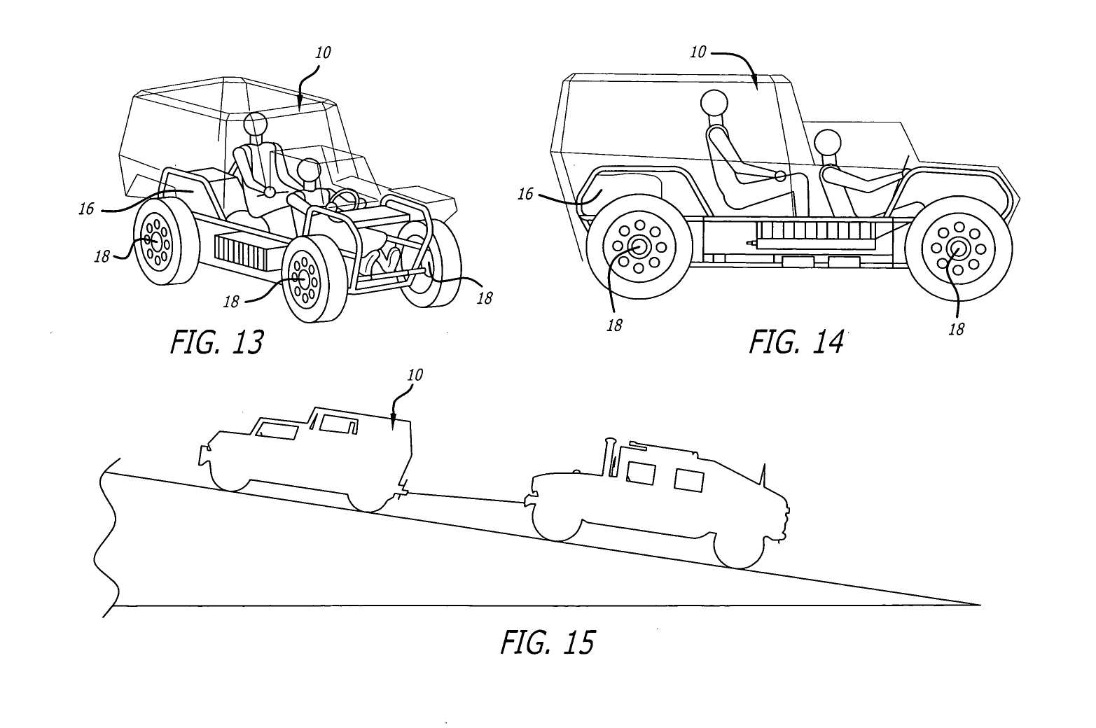

The core vehicle includes a chassis and main body tub, with other components including wheel hub motors and suspension modules, a removable engine and generator module, an electronics/radio compartments, a flatbed, a front cockpit cover, an enclosed cabin, a front bumper and winch module, and a rear bumper. The modules are designed to minimize the number of tools required for integration, with quick disconnect couplers for minimizing the time required to replace or interchange modules. The vehicle is powered by a diesel/electric hybrid drive 16 which may include, as illustrated in FIGS. 13-14, a turbocharged diesel that drives a generator, the generator powering up battery packs, and the battery packs and generator powering four electric hub motors 18, one in each wheel. It may have a very large generator 20 onboard (such as one-hundred kilowatts), as shown in FIG. 2, which can provide power independent of the vehicle for field hospitals, disaster relief operations, refugee camps, evacuation areas, critical data and communications centers, crisis management centers, forward operations bases, staging areas, airfield towers, runway lights, emergency power for homes, and supply and maintenance depots. It has a driver's cockpit and choice of interchangeable rear sections, which can be an enclosed rear cabin or an open flatbed, can be armored or not armored, where the non-armored version will carry a very large load, and the armored version will carry a large load, and an extender module substantially increases the load carrying capacity of the vehicle. It will drive on and off of a V-22 Osprey tiltrotor aircraft manufactured by Boeing Corporation, and all larger aircraft, has a rear facing situational awareness camera system, has been designed to support weapons mounts for organic Infantry/Battalion weapons, and also to support remote operated weapons stations. A wide variety of weapons systems may be utilized.

The vehicle enhances survivability with armor protection 22 that allows soldiers to survive an initial ambush contact, and with superior firepower, speed and agility, that enables soldiers to assault their attackers with overwhelming force, or to break contact in order to flank or evade, as seen in FIGS. 9-11. Also, the hull and cockpit design include angled hull surfaces to deflect shrapnel, reduce radar trap-reflection areas and the radar signature, reduce horizontal and vertical non-natural lines, working with camouflage to help break up the vehicle image and aid concealment, and provides thicker cross-section of armor material between the solders inside and incoming projectiles.

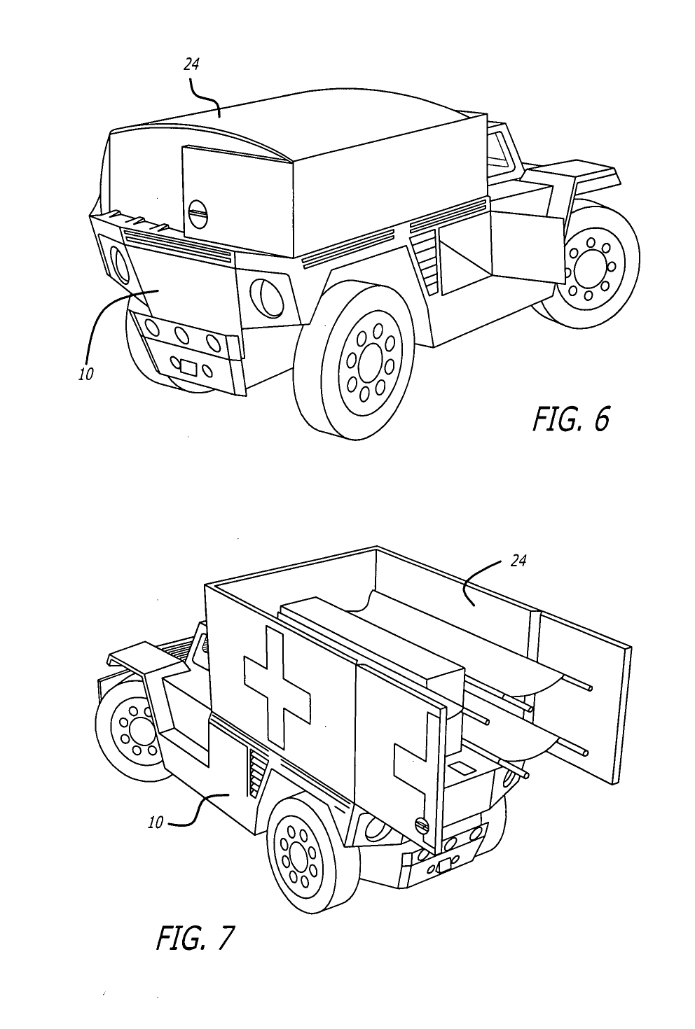

The vehicle may also include a shock absorbing ram bumper, to dampen impact when ramming through barricades or pushing obstacles out of the way, for protecting the vehicle when pushing burning objects, and providing additional small arms protection for tires, hub motors, and the driver, which has no protrusions that may impale an obstacle and drag it or prevent the vehicle from backing off of it. It also may include a rear-view and front view camera for day/night situational awareness for the driver, with a field of view such as one-hundred degrees, illuminated out to a range such as twenty-five meters, invisible to the naked eye, and a ruggedized daylight readable monitor in the front cockpit, also useable as a VGA GPS navigation screen. The vehicle 10, as in FIGS. 6 and 15, is able to cruise at high speed, such as sixty-five miles per hour, and accelerate rapidly, as zero to seventy in seventeen seconds, fully loaded, with a load such as eighty-six hundred forty pounds, and is able to climb a steep incline, as a six percent grade, towing a vehicle, as a ten-thousand pound vehicle.

The open flatbed vehicle has stackable walls that can be armored or not armored, has a removable roof with built in roll-cage that can be armored or not, has ample room for personnel, or more with an extender, can be configured to carry litters inside armored walls, or litters and an onboard medic, can carry a large water or fuel bladder inside armored walls or a larger bladder with the extender.

The enclosed rear cabin vehicle can mount a remote operated weapon station, seats one person besides a driver, and a third person can be seated in a three hundred sixty degree rotating weapons turret, has the capability for vehicle operation to be transferred from the primary operator seat to the secondary operator passenger seat while the vehicle is in motion, and can house an electro-optical surveillance/antenna mast. Additionally, side cantilevered doors can articulate in several semi-opened positions while providing space for two additional soldier/police personnel to sit on the swing arms and be protected or partially protected while operating non-stationary and stationary auxiliary gun systems.

The enclosed cabin vehicle enables it to be a two person version which can be driven on and off a V-22 Osprey. It also has the option of a further person in an electronically rotatable roof turret on the rear top of the vehicle. The base flatbed version can be used as a flatbed, or sectional stake-bed walls can be added thereto. The stake-bed walls can be armored or not. The walls may come in panels 24, such as ten or eighteen inches high, as in FIG. 6, allowing the modular vehicle with one section of bedwall to be driven on and off a V-22 Osprey. Additional sections can then be added and locked in place. As sections of wall are added, sections of roll cage can be added. Wall panels can be stacked to create an enclosure, such as eighteen, thirty-six or forty-six inches high, around a bed that may for example be fifty-seven or sixty-six inches long. It can all be tied together and made effective by adding a roof piece or crosspieces. The roll cage and weapon mounts enable forward and rear or corner mounted machine guns, in a gun truck variant, to have unobstructed movement between forward, rear, and side fields of fire.

The vehicle includes features such as versatility and modularity, with multiple interchangeable components, including an enclosed rear cabin or an open flatbed, also enabling switching between the two. The power plant is able to power the vehicle or be removed from the vehicle and used independently to provide power for other uses. The armor and the ability to exit the threat area greatly aids the survivability of personnel in the vehicle. Further features include the tandem seating of personnel, the ability of the vehicle to be loaded into, stored, transported, and taken off specialized aircraft, the independent drive systems, the front wheel hub motors enabling continued mobility if less than all the tires are shot out, the rear person being able to have full control and the ability to drive separately from the person in front, the submersibility, and the cockpit size. Also featured are the location of air intakes in the rear, and the ability to shut the diesel engines off and run on electricity in desert sand storms or like conditions, with filters and no direct air intake into the vehicle, enables continued operations or exiting the area while the enemy cannot, with the potential consideration to hermetically seal the cabin and its occupants and reduce the hostile environment of potential sand storm, oil fire, and/or chemical and biological threats, and greatly increase the engine and vehicle's life through serviceability. The operator has the ability to pull the air filters, which are located in a tube that goes through the rear space of the enclosed cabin, take an extra air filter available in the vehicle and change the air filter while the vehicle is moving, and clean the dirty air filter for re-use. Still further features include the capability of readily changing the cab and the configurations by taking off the cab and putting on another platform, the versatility including operations as a hauler of equipment, the extender including hub wheel motors with the capabilities to attach to the back of the vehicle and to hookup into the electrical system with its own extender drive, and a multiplicity of redundant backup systems that enable continued operations, including each wheel having an electric hub motor, each side having an independent electric box, and each tire having a runflat insert.

The modular vehicle is able to meet the specific payload constraints for air transportability of a family of tactical ground modular vehicles, and for enabling the tactical vehicle to interface with and integrate in a relatively small highly specialized tiltrotor aircraft such as a V-22 Osprey. It is able to be rapidly loaded, deployed, and unloaded. Also, the modular vehicle is able to meet the particular requirements for internal transportability, and for enabling rapid loading over the cargo ramp, ramp, ramp tunnel, and cabin floor, without damaging the aircraft.

The vehicle may include power generation by a diesel electric hybrid motor, enabling scrapping of the transmission and gearing. A controller enables operations of crawling at very low speed to driving at very high speed, such as extreme crawling four wheeling to high speed freeway running, from low torque to high speed. The fuel tank is in a unit, but the radiator is in the front of the vehicle, with a quick release mechanism, that enables unplugging, pulling out, and replacement. The diesel engine and generator unit may also be a mobile platform for generating electricity, to be pulled out and used independent of the vehicle in the field as a generator, running for example as a hospital electric supply, while the vehicle is able to be used for search teams. The vehicle can still be driven back to base camp on the hub motor battery power to pick up another unit. This enables use of the vehicle as an extreme mission vehicle, where, if one component goes down, others pick up for it. It is able to be flown into an area with a first load of supplies, get the supplies out to where they are needed quickly on the vehicle, then use the power supply independently to power the hospitals and with remaining power for vehicle search teams.

The power unit of the diesel engine, generator, and interface plate may be taken off of the vehicle, which is able to be taken apart, and the power unit may be stashed wherever it will fit, in the limited space in an aircraft such as a helicopter. The power unit may then be put together in any configuration needed for a specific mission, to stand alone separated from the vehicle. It can be dropped off in the field, and armed, then subsequently, loaded onto the back or be reloaded, so the vehicle may carry around or separate from a very large output power plant for use as needed, to run the vehicle, or as an auxiliary very large power source for use independent of the vehicle, as to power of an entire area such as a city. The diesel may be turbo-charged, such that altitude and elevation do not impede its performance. The power unit is able to slide into position on the vehicle, then pins are extendible into holes in the vehicle to be locked in place.

The modular vehicle includes a controller, which is a functional unit that controls various input and output channels for enabling various operations of the vehicle. The controller includes a chip, software, and alterable programming code for enabling a family of vehicles to fit into an aircraft. The controller includes variable data for timing, and communications data for messages, and a platform that includes a core algorithm application, hardware driver firmware, and commodity components board layout hardware.

The controller includes hardware including a circuit board base layer, and firmware semi-permanently stored on a ROM computer chip, which includes special codes or computer language program translators. The controller further includes an application containing a computer program including the entire set of programs that collectively implement the process for the specific tasks of driving the hybrid system and the specific vehicle components, including a power balancing program for balancing power from the generator to the hub motors and from the batteries. It further includes a communications program for messages coming from each component, such as each hub motor, each battery pack, the generator, and/or the diesel engine, and for functions, such as increasing or decreasing speed, and dumping power to prevent overcharging of the batteries. The system can be programmed to enable locking in a particular steady speed, for all systems to work in concert, as for example for a slow speed for towing a load up a grade, or on a downgrade.

One independent battery-powered electric hybrid motor goes inside the hub of each wheel, encasing itself and following a magnet, with the more signals put through the faster it goes, each run by the diesel engine that runs a generator, which runs the hub wheels. The vehicle thereby also has backup storage batteries 16 to enable stealth, as seen in FIG. 2, in a silent, low heat signature, high speed, electric only operation, shutting the diesel engine off and running on the batteries. If something happens to the batteries, if damaged or inoperable, the vehicle can still be run by the generator. The diesel engine, and generator are mounted as a unit, and are readily replaceable upon unscrewing a small number of bolts, pulling the unit out, replacing it, and returning to the field.

Each hub motor is able to be cross-integrated with the wheels, with the hub assembly of the wheel, hub motor, shock, spring assembly, and A-arm connected to the vehicle by four bolts, whereby the assembly is able to be taken off the left front, for example, and put anywhere else on the vehicle, on the right front, right rear, or left rear, being completely interchangeable, front to back, left to right. An interchangeable hub assembly including a longer A-arm length in each hub assembly would enable the vehicle to ride higher with greater ground clearance for a rugged terrain environment where the vehicle is not being transported in a specialized aircraft, pushing the wheels out to the side, increasing the stability of the platform.

To load the vehicle on the aircraft, it is important for the vehicle to move up the ramp and onto the aircraft in a straight line, to prevent damage to the vehicle and/or the interior of the aircraft from even slightly angled and off-center vehicle movement. The vehicle may include a winch on each bumper, each with a special fixed eye, and a cable lug for hookup, to keep the winch retracting in centered position, providing a centered guideline, and enabling the vehicle to be loaded onto and unloaded from the aircraft in a straight line from the start, and throughout the movement thereof, in tight spaces, and from either the front end forward or the back end backing in. Alternatively, or as a backup system in the event that the winch system fails to perform properly, the vehicle may include a laser system in the front end and the back end of the vehicle hooked up mechanically, which does not require sighting by the operator, whereby the laser is turned on and the vehicle automatically follows the laser for centered loading thereof. In loading the vehicle into the aircraft, it is important to protect the sides of the aircraft cargo area from damage. The aircraft may include guide rails for guiding the vehicle wheels straight into the aircraft. The guide rails may lie normally flat, and, for use, may be able to be raised so as to be positioned at the sides of the wheels to enable self-centering of the vehicle.

The problem of loading is particularly important in a small aircraft such as the V-22 Osprey, where there is very limited clearance on the sides between the vehicle and the sides of the aircraft, which may include side boards or buffer rails and/or folded-up seats for troops, so as to prevent damage thereto and to the side walls of the aircraft. To provide increased height clearance for the vehicle relative to the ceiling of the aircraft, to enable precise loading of the vehicle, the vehicle can be ratcheted down to stops in a rear A-arm suspension to take up travel in the suspension and lower the entire rear of the vehicle, with manual ratcheting hardware operating like a reverse jack and included in the vehicle. Execution of the properly loading sequences would provide the necessary side and top clearance to prevent vehicle and aircraft damage.

The loading process may be computerized so that the vehicle is locked in and then automatically loaded. An electronic laser system may be used for guiding the vehicle into the aircraft, with a laser emitted from the vehicle alignable with a light dot centered on the closed portion of the aircraft cargo hold, to be followed by the driver, which, if varied from straight on, a light goes on. Alternatively, a thin layer of silicone on the sides of the vehicle, if touched by the wheels, makes the sides of the wheels slick and slippery, enabling protected loading on the aircraft.

As the V-22 is a very small and very expensive aircraft, loading and unloading of the vehicle, which maximizes the cargo hold space, is a critical issue. In order to facilitate that, the vehicle will have an accompanying loading/offloading guide for the specific purpose of guiding the vehicle onto and off of the aircraft without damaging the aircraft. There are several ways that the vehicle can be loaded/off-loaded. Piloted by a driver in the vehicle, under vehicle-power or manpower, drawn in by the aircraft winch system, or by the winch on the vehicle. These methods are capable of operating at extremely slow speeds (such as one mile per hour or less).

Depending on which method is used to power the vehicle into the aircraft, the following guide methods may be utilized: an attachment to the guide cable, that has arms on each side with soft silicone tips. The tips are soft enough not to damage the aircraft interior and serve as guides for the cable as it pulls the vehicle in by winch power. An attachment to the winch cable, that uses either the cargo roller rails or the roller guides used to guide pallets into the aircraft to keep the vehicle in the center of the cabin space as it is winched or driven aboard. A rail, that attaches to the pallet guide rollers to prevent the wheels of the vehicle from traveling outside of definite boundaries, which will keep the vehicle centered as it is winched or driven on or off the aircraft. A laser guide, that tells the driver of the vehicle if he is off center as he drives on or off the aircraft. A laser guide, used to line the vehicle up on the ramp so it can be winched aboard by either the vehicle or the aircraft winch system which will sound an alarm if the vehicle veers off course, allowing for automated or manual guidance correction. Whisker-type attachments, that are attached to the vehicle immediately prior to loading in the aircraft. If these sensors brush against any portion of the aircraft, a warning light illuminates so the driver knows to steer away before the vehicle makes contact and damages the aircraft.

The modular vehicle may include an armor body integrated into the frame, as in FIG. 6, which is part of the modularity, providing three-hundred sixty degree protection for the operator, and may also be non-armored. It is adaptable between armor configurations (such as armored to NATO STANAG level three or level two protection). The unarmored version can haul very large loads, such as over four-thousand pounds. The armor may comprise smart armor, such as an opaque armor skin, including a sensing layer such as a mesh sensing sheet between armor plates, that take a hit from a projectile, with the projectile generating a trail in the sensing layer for the path of movement thereof, which instantaneously electronically determines the precise direction of the source of the fire even if the vehicle is in motion. An automatic response feature registers where the threat came from. The vehicle gun can then be directed to instantaneously automatically turn in the established direction and fire immediately, to return directed fire with a high probability of striking the target before the target can move. The automatically sensing and directed response feature can be over-ridden manually by the operator if there is a bigger threat from another direction, such as directly in front, or multiple rounds coming in. Acoustical pinpointing of snipers is not feasible in the middle of battle, with all kinds of noise from all types of fire and explosions from multiple directions going on. The instantaneous response of the smart armor in this vehicle enables the return fire to go virtually right back up the barrel of the sniper. The driver is protected on the sides by the armor, which is able to be kicked out by the driver along with the windows to enable him to exit the vehicle. Windows, armored and unarmored, may be coated with a coating that is scratch, dent, sand blast, and window pitting resistant, to enable continued visibility through the window in adverse conditions.

In the smart armor, two layers of sensor membrane are included in the layers of the armor material so that as a projectile passes through them, its angle of travel allows a computer to determine its back azimuth and elevation—and can instantly be used to target return fire from an automated system and/or human weapon operators. The speed and size of the projectile can also be recorded and used to determine the range of the weapon that fired the projectile—so that returned fire can be adjusted for elevation to account for the arc of the incoming round over long ranges. Different strike points on the outer membrane and the inner membrane determine trajectory between the two layers, and the elevation and back azimuth path of the projectile. The size of the hole in the outer membrane and the time lapse between penetration of the outer membrane and the inner membrane determine the projectile caliber and velocity, to determine the distance the projectile has traveled. Elevation, back azimuth, caliber and velocity are combined to determine precise location and range of the weapon that fired the projectile, which can be immediately (and automatically) targeted from the vehicle that was struck by the projectile, and/or, by other weapons platforms within range.

There is an extender unit that connects to the back end of the vehicle, which extends the vehicle, with each wheel having a hub motor, which hooks directly into the vehicle power plant battery packs, electrical and gasoline systems. A trailer can be pulled by connection to the rear bumper of either the extender unit or the vehicle. As the armor weight increases, the payload capacity goes down. The extender is needed particularly if the armor is increased to such a level where the payload capacity is coming down too low, such that the extender needs to be attached to get the payload capacity back up. The extender thereby increases payload capacity and adds more load carrying bedspace. It has an additional fuel tank, significantly increasing the overall vehicle range.

The seating is tandem, so that the front seat person is seated in a first position, with the rear seat person having a front line of sight elevated above and looking over the top of the front seat person, able to see forward, enabling operation as a mobile foxhole. If seating is not tandem, the rear person is closed off from the whole frontal field of fire, which is particularly important if the vehicle is the lead vehicle in a convoy. If there is an ambush going on, the rear person is able to shoot around the driver, and if the fire is in front, the rear person has full access, and the front person can keep driving without worrying about ducking because he is already fox hole hunkered down positioned below.

With the operators in tandem in the center of the vehicle, within the height and width constraints of the vehicle, either operator can get out either side, and then help the other operator, as contrasted with operations sitting side by side, such that if one is dead or wounded, and if the vehicle is upside down in a ditch, one has to go over the other to get out and release the other if that person's side is blocked. The person in the back has a backup system, to be able to manually operate and steer the vehicle if the person in front is disabled or wants to do something else, such as look at a map or operate weapon systems.

The front and rear bumpers have attachment points for pulling or other daily use, with the winch in the middle, with tow hooks hooking straight to the middle, with the tow line which is playing back and forth across the drum going through the center point which does not move, and pulling in a straight line through the center hole by triangulation with the attachment points and center hole. The configuration provides a guide for the vehicle on the loading ramp of the aircraft such that the angle cannot change once it establishes the geometry of going straight. The tow line pulls the vehicle into a set configuration, and then the button or laser guide activates to automatically load the vehicle in a straight line which can be monitored or displayed inside the vehicle.

The rear bumper, in normal position, is up against the back of the vehicle. It can be lowered to be in load-carrying, weight-bearing function, to enable tying down a load, carrying gas cans, such as long range fuel tanks that go directly on the lowered bumper and are discarded after use, or having personnel standing thereon, while still enabling a trailer to be towed thereunder. To add the extender or pull the engine unit out, the bumper is removable by removing four pins. The bumper can then be installed by being hooked on the back of the extender.

A heavy-duty type air filter system, such as an oil-bath filter system for filtering out debris so that only air gets through, may be located on top of the vehicle, which protects the diesel engine in sand environments, and is attachable after transport of the vehicle in a specialized aircraft.

The roof canopy 26 slides so as to come all the way out to the front to enable entry into and exit from the vehicle, as shown in FIGS. 1, 3-4 and 9-11. In the event of an accident, a rollover, or an attack that renders the vehicle inoperable, there are multiple emergency escape components 28, as illustrated in FIG. 4. For the front cockpit, if someone is trapped inside the vehicle, when the vehicle is upside down or blown over onto its side, the canopy may be torqued enough so that it cannot slide forward, and therefor both sides of the canopy are rigged with an explosive system, that explodes, and cuts the bolts that are holding it together, to allow the canopy sides to fall away. A single switch triggers the explosive system, that detaches the side windows and side electronics boxes, and propels them away from the vehicle, instantly creating avenues of escape out the left side and right side of the front cockpit. Also, the front cockpit slides all the way forward against stops, or, if needed, comes all the way off the vehicle. The front seat lies back so the driver can escape through the rear cabin. The top and front windows of the rear cabin are removable from the inside. The front seat lays forward so the rear occupant can escape through the front cockpit.

The person in the rear seat is able to exit the vehicle through one of the side doors, whereby upon opening the front canopy, taking the two windows up, that person can come out to the inside, or push the front seat forward and climb out the front, so the operator can get out. The back door opens down like the tailgate of a truck, also enabling the rear seat operator to exit that way, and so a stretcher can slide in there, with the back end of the opened door holding the outside legs of the stretcher, enabling two operators and a stretcher to be able to be accommodated in the core vehicle. Another version of the vehicle may be a reserve/medical evacuation vehicle, with armored walls and roof.

The vehicle cabin may be made in one piece, and may comprise a composite tub over a metal frame, including level two armor and thickened and protected glass. Alternatively, for a larger degree of mine protection, steel may be utilized. The modularity of the vehicle enables changeover of the vehicle on the ground in the theatre of operation, as changing over to steel armor on the ground after transporting the vehicle with lighter weight armor for enabling the aircraft floor to support the vehicle.

There are electronics boxes on each side of the front canopy, in the gaps between the seat and the sides of the canopy, for radio equipment, auxiliary equipment, transponders, detectors, and the like, with DC and AC power available, which are out of the way for enabling entry into and exit from the vehicle.

Turret gun bearings have been a problem, in that, for example when multiple pounds of weapons or ammunition are on one side, the other side or back is dragging against a surface that does not have bearings on it, so that to be counter-balanced ammunition has been stacked on the back. If the vehicle is on the side of a hill, the ammunition needs to be pushed around to serve as a counter-balance, and as ammunition is used, the counterbalance on the back is lost, with all the weight on the front. In slinging the turret gun around to counter-balance, it may be so heavy as to make operations difficult.

The turret gun bearings in the vehicle are tube bearings sloping outwardly, not round bearings, so that even if all the load is on one side, the turret rotates freely. An electric motor turns the turret guns, to enable the operator to swing it freely, since the operator is in a sling seat without room in the vehicle to stand, and with the majority of his body below the level of the vehicle such that he will not have enough movement of his legs to swing the turret gun around. The turret takes care of windage, left and right movement, and all the operator has to do is move the gun elevation up and down.

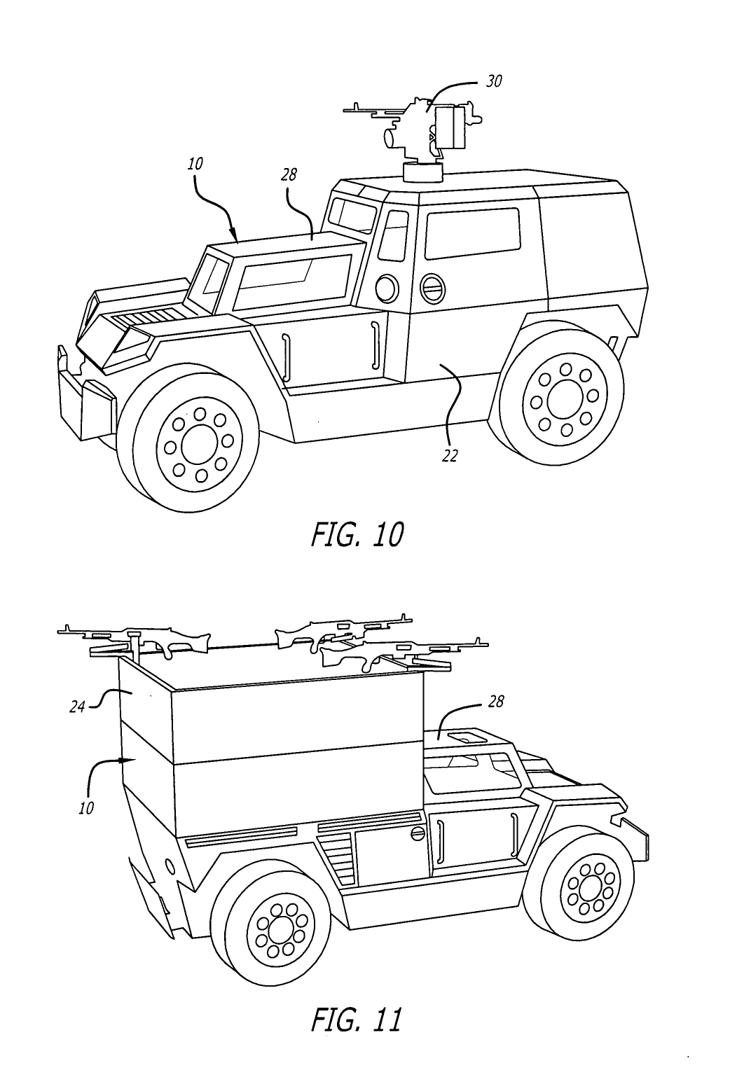

The vehicle may include a remote weapon station 30 which may be roof-mounted, and which is controlled from inside the armored cabin, as in FIG. 10. A missile system, such as a TOW or stringer missile system, can be mounted on the vehicle where there is no turret gun operator, with the electric drive driving it around and the windage being handled, so that only the elevation is needed. The whole platform need not be above the vehicle, with half already in the vehicle.

Other versions of the vehicle include an open (three across) rear seat and small cargo area in the rear, or a two person seat facing backward behind a forward facing three across seat. A roof mounted turret ring from an enclosed rear cab installed in a flatbed version with armored side walls, a field Medivac, with a roof, and/or with two stretchers and medic/corpsman on the other side, and/or the same thing with the extender so the enclosure can be fully sealed from the environment and/or hostile fire. Longer A-arm modules, so, in areas of operations where there is no need to travel on the V-22 Osprey, the longer A-arm modules can replace the standard ones. This will allow a higher ride height (more ground clearance), as well as pushing the tires outward, which will allow for greater lateral stability in all environments and at all speeds. Fender extensions can be added to prevent rocks, mud, debris, from kicking up and hitting the windows from the wider tire track. It may include a three-hundred-sixty degree camera/sensor mast. It may also include a radio signal blocking system, that creates a large safety zone around the vehicle, such as five hundred meters, blocking all radio signals except designated frequencies, to prevent the use of radio signals to command detonate roadside bombs or the like.

Formed or airfilled pontoons that are harnessed together so they can be laid out on the ground. The vehicle then drives up on the pontoons (holes will be spotted for the wheels). The pontoons will be raised and strapped securely to the vehicle. The vehicle will then be able to drive into water and float, using its wheels for propulsion and steering (steering is achieved by counter rotating the wheels left side reverse, right sight forward, etc.) A thruster can be attached to the underside or rear of the pontooned version, and run off the batteries, to provide jet or prop thrust in the water.

A subframe with tracks may be used in certain types of terrain and/or certain climactic conditions. The wheel/A-arm modules will be replaced with suspension modules, the hub motor will then, instead of turning a tire, turn a sprocket or gear that drives the tracks. This gearing may be offset to allow the tracks and roadwheels sufficient clearance under the battery boxes on the sides of the vehicle. In a light, conventional drive version the vehicle will be basically the same in function. It will fit on the V-22 Osprey (and because it doesn't have the generator, batteries, electronics and hub motors and hub motor drives, it will be lighter, and will require a larger diesel engine and a transmission and four wheel drive mechanical drivelines). The combustion drive and mechanical driveline will have additional engineering for a vehicle this small, with the suspension travel maintained. The conventional drive will not have the remote power generation as a standard attribute. The lightweight conventional drive vehicle will have the exact same modular adaptability and functionality. Also, the vehicle systems are capable of being implemented with robotic or electronic remote controls, such that the vehicle can be driven by another vehicle or operated from a remote location, such as from aircraft, other ground vehicles, or soldiers at distant secure base locations. An unarmored vehicle can be sent ahead of a convoy to prematurely detonate ordinance before manned vehicles are sent in.

While the particular modular vehicle system and method, as described and shown in detail above and in the Figures, is fully capable of obtaining the objects and providing the advantages as stated herein, it is to be understood that it is merely illustrative of the presently preferred embodiment of the invention, and that no limitations are intended to the details of construction or design shown herein other than as described in the appended claims.

We claim:

1. A modular vehicle system, for enabling configuration thereof as required, comprising:
a core vehicle; and
a first module, for enabling configuration of the core vehicle as required, able to be integrated into the core vehicle, and able to be disconnected from the core vehicle for interchange thereof with another module.

2. A modular vehicle system as in claim 1, wherein the core vehicle includes a chassis, a main body tub, mounted on the chassis, and components, connectable relative to the chassis and the main body tub.

3. A modular vehicle system as in claim 1, further comprising a second module, for enabling configuration of the core vehicle as required, able to be integrated into the core vehicle, and able to be disconnected from the core vehicle for interchange thereof.

4. A modular vehicle system as in claim 2, wherein the components include wheel hub motors.

5. A modular vehicle system as in claim 2, wherein the components include suspension modules.

6. A modular vehicle system as in claim 2, wherein the components include a removable engine and generator module.

7. A modular vehicle system as in claim 2, wherein the components further include electronics, radio, and computerized components.

8. A modular vehicle system as in claim 2, wherein the components include smart armor, including an opaque armor skin, and sensory layers, to track a projectile out to the source electronically, and to automatically sense the location of the source.

9. A modular vehicle system as in claim 2, wherein the components include an extender unit, connectable to the modular vehicle, which includes a plurality of wheels, wherein at least one wheel includes a hub motor.

10. A modular vehicle system as in claim 2, wherein the components include a loading guide for enabling loading of the modular vehicle in an aircraft.

11. A modular vehicle system as in claim 2, wherein the components include a flat bed.

12. A modular vehicle system as in claim 2, wherein the components include a front cockpit area.

13. A modular vehicle system as in claim 2, wherein the components include an enclosed cabin.

14. A modular vehicle system as in claim 2, wherein the components include a rear bumper.

15. A modular vehicle system as in claim 2, wherein the components include tandem seats.

16. A modular vehicle system as in claim 2, wherein the components include a diesel/electric hybrid drive.

17. A modular vehicle system as in claim 2, wherein the components further enable towing of a towed vehicle.

18. A modular vehicle system as in claim 2, wherein the components include stackable wall panels.

19. A modular vehicle system as in claim 2, wherein the components include a removable roof.

20. A modular vehicle system as in claim 2, wherein the components include a rotating weapons turret.

21. A modular vehicle system as in claim 2, wherein the components include articulatable side counterlevered doors.

22. A modular vehicle system as in claim 2, wherein the components include a roll cage.

23. A modular vehicle system as in claim 2, wherein the components enable the modular vehicle to be submersible.

24. A modular vehicle system as in claim 2, wherein the components inhibit direct air intake.

25. A modular vehicle system as in claim 2, wherein the components include a quick-release radiator.

26. A modular vehicle system as in claim 2, wherein the components enable the modular vehicle to be readily disassembleable.

27. A modular vehicle system as in claim 2, wherein the components include a rear bumper, able to lower the load carrying weight bearing thereof.

28. A modular vehicle system as in claim 2, wherein the components include a removable bumper.

29. A modular vehicle system as in claim 2, wherein the components of the modular vehicle includes tracks.

30. A modular vehicle system as in claim 3, wherein the second module is able to be interchanged with the first module for integration into the core vehicle.

31. A modular vehicle system as in claim 3, wherein the first and second modules include quick disconnect couplers for enabling interchange thereof.

32. A modular vehicle system as in claim 6, wherein the removable engine and generator module comprises a power module sled.

33. A modular vehicle system as in claim 7, wherein the components include remote controls.

34. A modular vehicle system as in claim 7, wherein the components include a controller, which enables very low speed control, and very high speed running.

35. A modular vehicle system as in claim 7, wherein the components include a ruggedized daylight readable monitor.

36. A modular vehicle system as in claim 7, wherein the components include a navigation screen.

37. A modular vehicle system as in claim 7, wherein the components include a high cruise speed control.

38. A modular vehicle system as in claim 7, wherein the components include a loaded acceleration control.

39. A modular vehicle system as in claim 7, wherein the components enable climbing a steep incline.

40. A modular vehicle system as in claim 7, wherein the components include primary-secondary operator switchable controls.

41. A modular vehicle system as in claim 7, wherein the components include a surveillance antenna mask.

42. A modular vehicle system as in claim 7, wherein the components enable shutting off of one of the diesel/electric motors and running on the other.

43. A modular vehicle system as in claim 7, wherein the components include an air filter which is removable, changeable and able to be cleaned for reuse.

44. A modular vehicle system as in claim 7, wherein the components include redundant backup systems.

45. A modular vehicle system as in claim 7, wherein the components include an anti-flat tire insert.

46. A modular vehicle system as in claim 7, wherein the components include implementation and communications programs.

47. A modular vehicle system as in claim 7, wherein the components are able to ratchet down for stops for loading.

48. A modular vehicle system as in claim 7, wherein the components enable computerized loading.

49. A modular vehicle system as in claim 7, wherein the components include a backup system enabling operation of steering from the rear seat.

50. A modular vehicle system as in claim 7, wherein the components include heavyduty air flow systems.

51. A modular vehicle system as in claim 7, wherein the components include a slidable roof canopy.

52. A modular vehicle system as in claim 7, wherein the components include explosive side windows, and side structures which are detachable.

53. A modular vehicle system as in claim 7, wherein the components include electronics boxes.

54. A modular vehicle system as in claim 7, wherein the components include a missile system.

55. A modular vehicle system as in claim 7, wherein the components include a radio signal blocking system.

56. A modular vehicle system as in claim 10, wherein the loading guide comprises a front bumper and winch module.

57. A modular vehicle system as in claim 16, wherein the battery which is operable to enable stealth operation.

58. A modular vehicle system as in claim 20, wherein the modular vehicle includes a turret gun, and the components include turret gun bearings for substantially free rotation of the turret.

59. A modular vehicle system as in claim 23, wherein the components include elements for flotation, propulsion, wheels, steering, and thruster.

60. A modular vehicle system as in claim 38, wherein the controller includes a chip, software, and alternate programming code.

61. A method of enabling configuration of a modular vehicle system as required, in a system which includes a core vehicle, and a first module, for enabling configuration of the core vehicle as required, able to be integrated into the core vehicle, and able to be disconnected from the core vehicle for interchange thereof with another module, wherein the method comprises:
enabling configuration of the core vehicle as required, including enabling the first module to be integrated into the core vehicle, and to be disconnected from the core vehicle for interchange thereof with another module.

62. A method as in claim 61, wherein the core vehicle includes a chassis, a main body tub, mounted on the chassis, and components, connectable to the chassis and the main body tub, and wherein enabling in the method further comprises enabling the components to be connectable to the chassis and the main body tub.

63. A method as in claim 61, further comprising a second module, for enabling configuration of the core vehicle as required, able to be integrated into the core vehicle, and able to be disconnected from the core vehicle for interchange thereof, and wherein enabling in the method further comprises enabling integration of the second module into the core vehicle, and enabling disconnection of the second module from the core vehicle for interchange thereof.
